(19) United States
(12) Patent Application Publication
(10) Pub. No.: US 2026/0367788 A1
(43) Pub. Date: Nov. 19, 2026

(54) INPUT/OUTPUT PAGE MODIFICATION LOGGING

(71) Applicants: ADVANCED MICRO DEVICES, INC., Santa Clara, CA (US); ATI TECHNOLOGIES ULC, Markham (CA)

(72) Inventors: Nippon Raval, Austin, TX (US); Santosh Ravindranath Shukla, Bangalore (IN); Wei Sheng, Shanghai (CN)

(73) Assignees: ADVANCED MICRO DEVICES, INC., Santa Clara, CA (US); ATI TECHNOLOGIES ULC, Markham, ON (CA)

(21) Appl. No.: 19/210,903

(22) Filed: May 16, 2025

(51) Int. Cl. G06F 3/06

(52) U.S. Cl. CPC G06F 3/061; G06F 3/0655; G06F 3/0679

(57) ABSTRACT

Input/output (IO) page modification logging includes receiving, by an input/output memory management unit (IOMMU) of a computing system, a write request from an input/output (IO) device. The write request specifies a virtual address. The IOMMU is capable of translating the virtual address of the write request to a host physical address for a domain. A guest physical address for the virtual address of the write request is obtained. The guest physical address maps to a dirty page of the physical memory written in response to the write request. The IOMMU is capable of tracking the dirty page by creating an entry in a dedicated dirty page log buffer. The entry specifies, for the write request, the guest physical address and a domain identifier.

### TECHNICAL FIELD

This disclosure relates to logging input/output device page modifications in computing systems.

### BACKGROUND

A physical memory such as a random-access memory (RAM) or type of volatile memory of a computing system is often segmented into portions referred to as pages. Pages of physical memory are typically aligned to a particular page size. Pages may be accessed by a central processing unit (CPU)/hardware processor of the system. A page that has been written by the CPU/hardware processor or input/output (IO) devices of the computing system that has not yet been written back to non-volatile memory is referred to as a “dirty page.”

Presently, pages that have been written by IO devices, e.g., via direct memory access (DMA) operations, are tracked using translation tables. Example translation tables include IO nested page tables. When a page is written by an IO device operating under control of a virtual machine (VM), for example, a flag for the page is set within the IO nested page tables. The flags are typically called “dirty flags” and are set for different guest physical addresses (GPAs) for the dirty pages.

In cases where a VM is to be live migrated from a current, or source, computing system to a destination computing system, the dirty flags in the IO nested page tables of the source computing system may be used for improved memory management of the live migration. For example, the image file of the VM may be readily available to the destination computing system such that the VM may be spun up in the destination computing system from that image file. The dirty pages for the VM in the source computing system must be transferred to the destination computing system to preserve the current computing context of the VM to provide uninterrupted operation of the VM in transitioning from running in the source computing system to the destination computing system.

To do so, the dirty pages for the VM must be identified before they can be packed and forwarded to the destination computing system. Conventional techniques for transferring dirty pages written by IO devices use a software driven process that traverses the entire IO nested page table structure to detect each page in the source system having the dirty flag set that corresponds to the VM undergoing live migration. The conventional software-based process can consume significant time and bandwidth of the source computing system, thereby contributing to degraded performance in the live migration. Degraded performance of VM live migration may manifest as longer time for the live migration to complete and/or impeded operation of the VM during the live migration.

### SUMMARY

In one or more examples, a method includes receiving, by an input/output memory management unit (IOMMU) of a computing system, a write request from an input/output (IO) device. The write request specifies a virtual address. The method includes translating, by the IOMMU, the virtual address of the write request to a host physical address for a domain. The method includes obtaining a guest physical address for the virtual address of the write request. The guest physical address maps to a dirty page of the physical memory written in response to the write request. The method includes tracking, by the IOMMU, the dirty page by creating an entry in a dedicated dirty page log buffer. The entry specifies, for the write request, the guest physical address and a domain identifier.

In one or more examples, a computing system includes a hardware processor and a physical memory. The physical memory includes translation tables and a dirty page log buffer. The computing system includes an IOMMU coupled to the hardware processor and the physical memory. The IOMMU is capable of performing operations. The operations include receiving a write request from an input/output (IO) device. The write request specifies a virtual address. The operations include translating the virtual address of the write request to a host physical address for a domain. The operations include obtaining a guest physical address for the virtual address of the write request. The guest physical address maps to a dirty page of the physical memory written in response to the write request. The operations include tracking the dirty page by creating an entry in a dedicated dirty page log buffer. The entry specifies, for the write request, the guest physical address and a domain identifier.

This Summary section is provided merely to introduce certain concepts and not to identify any key or essential features of the claimed subject matter. Many other features and implementations of the disclosed technology will be apparent from the accompanying drawings and from the following detailed description.

### BRIEF DESCRIPTION OF THE DRAWINGS

The accompanying drawings show one or more implementations of the disclosed technology. The drawings, however, should not be construed to be limiting of the implementations to only the examples shown. Various aspects and advantages will become apparent upon review of the following detailed description and upon reference to the drawings.

FIG. 1 illustrates an example computing system capable of input/output (IO) page modification logging.

FIG. 2 illustrates an example of a computing environment that includes multiple computing systems capable of performing live virtual machine migration.

FIG. 3 illustrates an example method of IO page modification logging.

FIG. 4 illustrates an example of a dirty page log buffer.

### DETAILED DESCRIPTION

While the disclosure concludes with claims defining novel features, it is believed that the various features described within this disclosure will be better understood from a consideration of the description in conjunction with the drawings. The process(es), machine(s), manufacture(s) and any variations thereof described herein are provided for purposes of illustration. Specific structural and functional details described within this disclosure are not to be interpreted as limiting, but merely as a basis for the claims and as a representative basis for teaching one skilled in the art to variously employ the features described in virtually any appropriately detailed structure. Further, the terms and phrases used within this disclosure are not intended to be limiting, but rather to provide an understandable description of the features described.

This disclosure relates to logging input/output (IO) device page modifications in computing systems. Virtual machine (VM) live migration is a process routinely used within data centers such as hyperscaler type data centers. VM live migration refers to the process of moving a running, or executing, VM from one physical computing system referred to as a source system to another physical computing system referred to as a destination system without interrupting services and/or applications that are executing on the VM being migrated. VM live migration allows the data center to provide redundancy and load balancing.

Dirty page tracking and page faulting are two operations that help to reduce the time required for VM live migration. Typically, software entities such as a hypervisor, a VM manager (VMM), and/or certain operating systems (hereafter collectively referred to as a “hypervisor”) perform dirty page tracking as a software process by maintaining a bitmap field of dirty pages. The hypervisor marks each page of physical memory mapped to a virtual space as write-protected. Whenever a write operation to such a page occurs, the host processor or central processing unit (CPU) receives a page fault of a write access type. The hypervisor handles the page fault by updating the bitmap field for that page.

Page modification logging (PML) is a technology that offloads the dirty page tracking performed by the hypervisor (e.g., in software) to hardware in the CPU. A hardware circuit within the CPU performs dirty page tracking by updating the dirty flag bits of a page table entry and logs the guest physical address to an in-memory buffer thereby reducing the overhead of the tracking process. A page table entry records pages of physical memory that have been modified but not yet written back to non-volatile storage. The in-memory buffer is visible to the hypervisor. The CPU is capable of signaling the hypervisor to handle the dirty page bitmapping. This signaling, in the virtualization domain, may be implemented as a “virtual machine exit” (VM exit). The hypervisor is capable of decoding the VM exit reason, copying the guest physical address from the in-memory buffer, and passing on a list of guest physical addresses to a work thread for the VM live migration for further processing.

Though PML provides significant benefits, such hardware acceleration has been a CPU only feature. CPU-based PML does not track page modifications initiated by IO devices as such operations are typically performed via direct memory access (DMA) operations that do not involve the CPU. Also, not all IO devices support page faulting. Still, accurate transfer of pages of physical memory as modified by IO devices to the destination system is needed to effectuate VM live migration.

In accordance with the example implementations described within this disclosure, an input/output memory management unit (IOMMU) of a computing system is adapted to provide hardware accelerated logging of IO device page modifications. The IOMMU is capable of maintaining a dirty page log buffer. The dirty page log buffer may be dedicated, or reserved, for storing entries that specify, at least indirectly, dirty pages. The dirty pages within the dirty page log buffer are pages of physical memory that have been written by IO devices by way of DMA write operations. The IO devices, in initiating DMA writes, may belong to a particular domain (e.g., a particular VM or the host system). In cases where the rate of IO page modification is high, or exceeds a predetermined or threshold rate, dual buffer techniques and overflow handling may be used.

By adapting the IOMMU to perform IO device page modification logging, the example implementations transform IO device page modification logging from a software-based process to a hardware-accelerated process. The dirty page log buffer, which specifies an accumulated list of dirty pages written by IO devices, is made available to the hypervisor. The hypervisor is able to quickly obtain the list of dirty pages for a given VM undergoing live migration. The hypervisor may pass on the list of dirty pages to a live migration worker thread to effectuate VM live migration in less time than conventional software-based techniques.

Further aspects of the disclosed technology are described below with reference to the figures. For purposes of simplicity and clarity of illustration, elements shown in the figures have not necessarily been drawn to scale. For example, the dimensions of some of the elements may be exaggerated relative to other elements for clarity. Further, where considered appropriate, reference numbers are repeated among the figures to indicate corresponding, analogous, or like features.

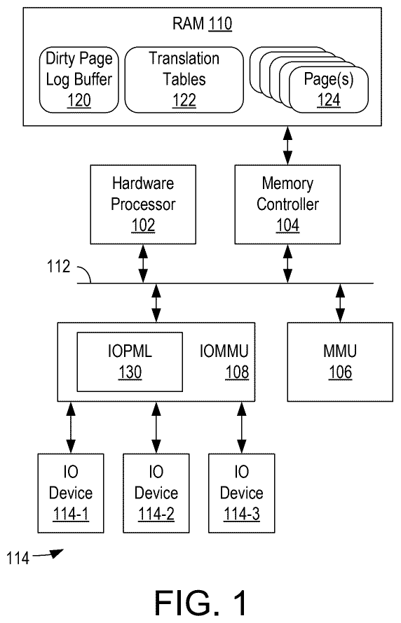

FIG. 1 illustrates an example computing system 100 capable of IO page modification logging. In the example, computing system 100 includes a hardware processor 102, a memory controller 104, a memory management unit (MMU) 106, an IOMMU 108, and a random-access memory (RAM) 110. In the example, hardware processor 102, memory controller 104, MMU 106, and IOMMU 108 are coupled by interconnect circuitry 112. As pictured, memory controller 104 is coupled to RAM 110. IOMMU 108 may be coupled to one or more IO devices 114 illustrated as IO devices 114-1, 114-2, through 114-3. The particular number of IO devices 114 illustrated is not intended as a limitation of the examples described herein. Examples of IO devices 114 may include, but are not limited to, Non-Volatile Memory Express (NVMe) devices, Universal Serial Bus (USB) controllers (e.g., USB eXtensible Host Controller Interface devices), Network Interface Cards, Graphics Processing Units (GPUs), and/or the like.

Hardware processor 102 may be implemented as one or more circuits (e.g., processors, cores, or the like) capable of executing computer-readable program instructions (program instructions). In one or more examples, hardware processor 102 may be embodied as a central processing unit (CPU). Hardware processor 102 may be implemented using any of a variety of architectures such as, for example, a complex instruction set computer architecture (CISC), a reduced instruction set computer architecture (RISC), a vector processing architecture, or other known architecture. For example, a hardware processor may be implemented using an x86 architecture (e.g., IA-32, IA-64), a Power Instruction Set Architecture (ISA), an Advanced RISC Machine (ARM) processor architecture, or the like.

Memory controller 104 is capable of managing communications with RAM 110. Memory controller 104 is capable of receiving read and write requests from other components of computing system 100 such as hardware processor 102 and/or IOMMU 108. Memory controller 104 is further capable of performing reads of and/or writes to RAM 110 in response to the received requests, e.g., from hardware processor 102 and/or DMA circuitry (e.g., accessed by or included in IOMMU 108).

MMU 106 is capable of translating virtual addresses (e.g., virtual memory addresses) to physical addresses (physical memory addresses). In general, MMU 106 is used by hardware processor 102 to perform such functions. For example, MMU 106 may translate guest virtual addresses (GVAs) and/or guest physical addresses (GPAs) to host physical addresses (HPAs). From the perspective of the host system, both GVAs and GPAs may be considered virtual addresses. For example, a GVA may be mapped to a GPA, which is in turn mapped to a HPA.

IOMMU 108 performs operations similar to MMU 106 with the exception that IOMMU 108 provides address translation and page protection for physical memory accessed via DMA operations initiated by IO devices 114 rather than for physical memory accesses by hardware processor 102. In some examples, IOMMU 108 facilitates IO device assignment within a VM platform where IO devices 114 may be assigned to different VMs, also referred to herein as “domains.” With device assignment, the assigned IO device 114 may run in, or be accessed by, the particular VM to which the IO device is assigned thereby allowing that VM to interact directly with the IO device (e.g., hardware) with minimal or no involvement of a hypervisor. In other examples, IO devices 114 may be accessed by different VMs, e.g., where an particular IO device 114 may be shared among a plurality of different VMs.

In some examples, drivers for IO devices 114 executing in different VMs (not shown) may specify GVAs or GPAs for DMA operations. The IO devices 114 submit DMA write operations. In cases where the DMA write request specifies a GVA, IOMMU 108 is capable of translating the GVA to a GPA and to an HPA for use in the DMA write operation. In the case where the DMA write request specifies a GPA, IOMMU 108 is capable of translating the GPA to an HPA for use in the DMA write operation.

RAM 110 is illustrative of a physical memory. RAM 110 may be implemented as volatile memory. RAM 110 is capable of storing program instructions such as a hypervisor and VMs (not shown) that may be executed by hardware processor 102. RAM 110 further may store data that may be used by executed program instructions and/or hardware components of computing system 100. In the example of FIG. 1, RAM 110 includes or stores a dirty page log buffer 120 and translation tables 122. Translation tables 122 may include guest nested translation tables and host nested translation tables that may be used by IOMMU 108 for translating GVAs and/or GPAs to HPAs.

As illustrated, RAM 110 may be segmented into portions or segments illustrated as pages 124. Each page 124 may be a predetermined amount of memory. For purposes of illustration and not limitation, each page may be sized to 4 KB, though other page sizes may be used. Hardware processor 102 is capable of executing program instructions to perform one or more operations as described within this disclosure. IO Devices 114 may further include non-volatile memory (e.g., one or more NVMe devices).

Interconnect circuitry 112 may be implemented as a communication bus through which the various components of computing system 100 may communicate. The various components of computing system 100 may connect to interconnect circuitry 112 through respective interface circuits. As an illustrative and nonlimiting example, the communication bus may be implemented as a Network-on-Chip (NoC) though the particular examples described herein are not intended to be limiting.

In the example of FIG. 1, IOMMU 108 includes an IOPML (Input/Output Page Modification Logger) 130. IOPML 130 is capable of performing several different operations that allow tracking of modifications of pages 124 as a consequence of IO device 114 initiated DMA write operations. In one or more examples, IOPML 130 is capable of tracking pages written (e.g., dirty pages) by IO devices 114 via DMA write operations using translation tables 122. IOPML 130 is capable of setting a dirty bit in translation tables 122. The dirty bit corresponds to, or is part of the entry for, the GPA for a given DMA write operation. In one or more examples, the dirty bit(s) may be set and maintained in the particular set of translation tables 122 that map GVAs to GPAs. In one or more examples, the dirty bit(s) may be set and maintained in the particular set of translation tables 122 that map GPAs to HVAs. In one or more examples, the dirty bit(s) may be set in both the particular set of translation tables 122 that map GVAs to GPAs and in the particular set of translation tables 122 that map GPAs to HVAs.

The HVAs may be obtained by IOMMU 108 looking up the virtual address (e.g., GVA or GPA as the case may be) specified by the write request in translation tables 122. In addition, IOPML 130 is capable of maintaining dirty page log buffer 120. Dirty page log buffer 120 is a buffer that is dedicated to, or reserved for, tracking dirty pages, i.e., pages 124 that were written by a DMA operation of an IO device 114. In one or more examples, dirty page log buffer 120 stores only entries for dirty pages written by DMA operations of IO devices 114. Clean, or unwritten pages will not be stored or tracked in dirty page log buffer 120. Similarly, pages accessed by the CPU, clean or dirty, are not tracked, maintained, or stored in dirty page log buffer 120. In this regard, for purposes of discussion herein, the dirty page log buffer 120 is said to store only dirty IO pages in reference to pages that have become dirty by operation of a DMA operation initiated by an IO device 114.

FIG. 1 illustrates an example of a computing system 100 that may be realized in a variety of different form factors and/or hardware architectures. It should be appreciated that any combination (e.g., one or more or each) of hardware processor 102, memory controller 104, MMU 106, IOMMU 108, and/or RAM 110 may be implemented as a separate, discrete IC device implemented in its own package. Alternatively, any combination (e.g., one or more or each) of hardware processor 102, memory controller 104, MMU 106, IOMMU 108, and/or RAM 110 may be implemented as one or more integrated circuits contained within a single device, e.g., contained in a single package. The device may be implemented with the components being implemented on a single, monolithic die or implemented as a plurality of different, interconnected dies or chiplets using any of a variety of different multi-die technologies. In some examples, computing system 100 or various combinations of the components of computing system 100 may be implemented as a System-on-Chip (SoC). Further, such devices may include multiple instances of the various components described (e.g., multiple hardware processors 102).

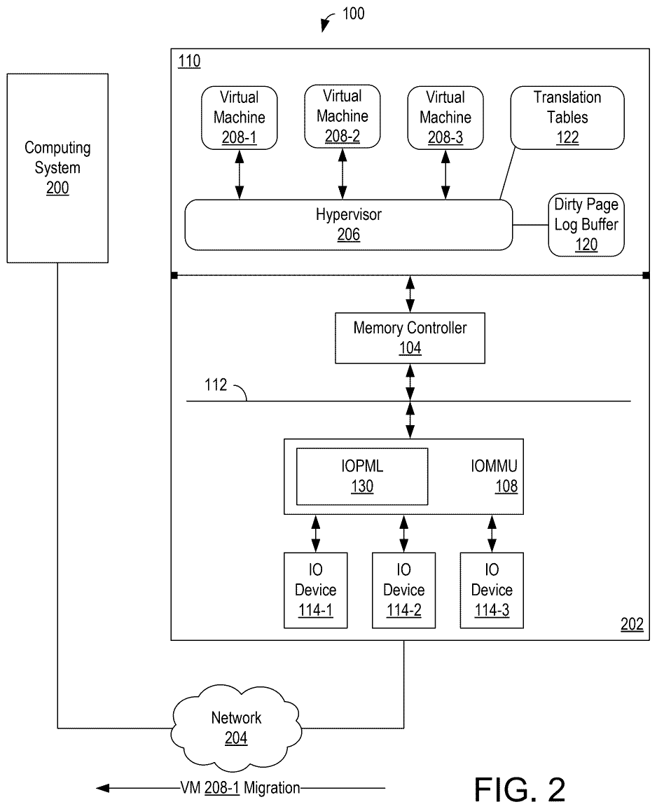

FIG. 2 illustrates an example of a computing environment that includes computing system 100 and a computing system 200. In the example of FIG. 2, computing system 100 and computing system 200 are distinct, physical computing systems. As an illustrative and nonlimiting example, each of computing systems 100 and 200 may be implemented as physically distinct servers. In another aspect, each of computing systems 100 and 200 may be implemented as distinct SoCs. As discussed in connection with FIG. 1, one or more or each computing system 100, 200 may be physically realized as a single System-on-Chip.

In the example of FIG. 2, some components of computing system 100 have been omitted for ease of illustration. Block 202 represents certain hardware, e.g., circuitry, of computing system 100. RAM 110 is illustrated separately only in as much as the entities illustrated within RAM 110 are program code and/or data structures that are executable and/or accessible by hardware processor 102. Computing system 200 may be implemented the same as or similar to computing system 100.

As illustrated, computing system 100 and computing system 200 are coupled, e.g., communicatively linked, via a network 204. For purposes of illustration, computing system 100 and computing system 200 may be disposed in a data center. The data center may be any of a variety of different sizes and have any of a variety of different capabilities. In some examples, the data center is a hyperscaler type data center.

In the example, computing system 100 (e.g., and computing system 200) executes a hypervisor 206 that is capable of managing one or more VMs 208 illustrated as VM 208-1, VM 208-2, and VM 208-3. Hypervisor 206 is capable of accessing, e.g., reading, dirty page log buffer 120. IOPML 130 is capable of tracking dirty pages written by DMA operation from IO devices 114 using dirty page log buffer 120 and translation tables 122 as described herein. The tracking information generated by IOPML 130 may be used by hypervisor 206 in implementing a live migration of a VM 208 from computing system 100 to computing system 200. For purposes of discussion, the particular VM 208 that is live migrated from computing system 100 to computing system 200 is VM 208-1.

In one or more examples, hypervisor 206 is capable of allocating dirty page log buffer 120 and mapping the base address of dirty page log buffer 120 to IOMMU 108 thereby making dirty page log buffer 120 available to IOMMU 108 and to IOPML 130. Dirty page log buffer 120 may be implemented as a circular buffer. In one or more examples, IOMMU 108 and/or IOPML 130 may expose the head pointer and tail pointer such that IOPML 130 is capable of writing to the tail of dirty page log buffer 120 using the tail pointer while hypervisor 206 is capable of reading from the head of dirty page log buffer 120 using the head pointer. In this manner, dirty page log buffer 120 is implemented in physical memory (e.g., RAM 110) and is readable by hypervisor 206.

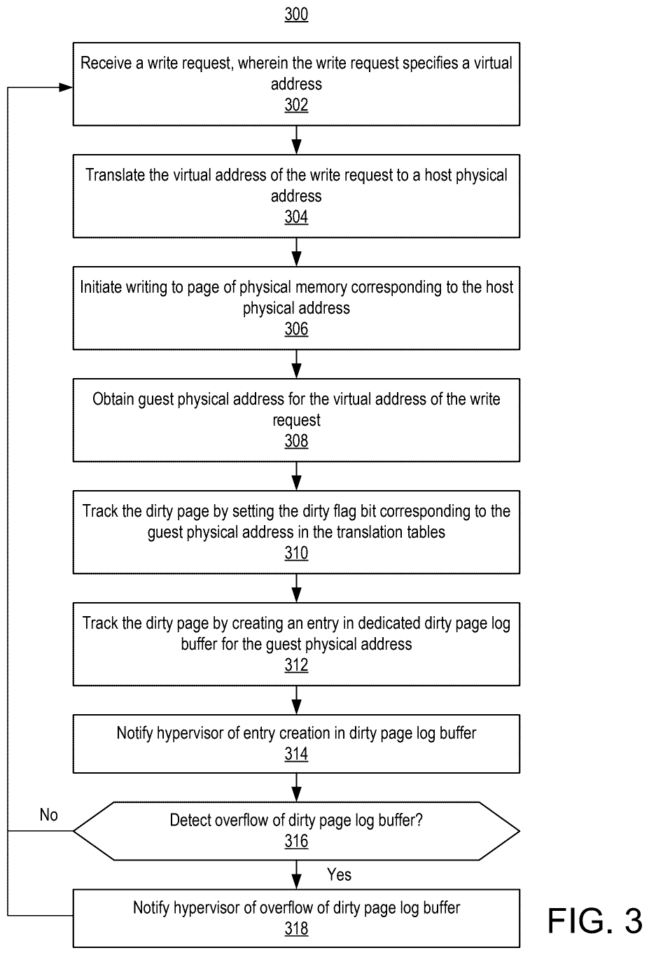

FIG. 3 illustrates an example method 300 of IO page modification logging. Method 300 may be performed by IOMMU 108 operating as part of a computing system such as computing system 100 of FIG. 1. As performed by IOMMU 108, the IO page modification logging is offloaded from a software process performed by hypervisor 206 to hardware thereby reducing the workload placed on software-based processes and/or hardware processor 102 and hardware accelerating the functions.

In block 302, IOMMU 108 receives a write request. The write request may be received by IOPML 130 operating as part of IOMMU 108. The write request is sent from an IO device 114 requesting a DMA write operation to a virtual address. The virtual address may be a GVA or a GPA. The virtual address corresponds to a portion of system memory, e.g., RAM 110, that has been allocated to the IO device 114.

In some examples, the IO device 114 may be allocated to, or be part of a particular domain. The domain may be a VM 208 such as that of VM 208-1 or the domain may be for the host system (e.g., hardware processor 102 and/or bare metal). In other examples, the IO device 114 may not be allocated to any particular domain whereas the write request may belong to a particular domain (e.g., VM or the host system). The write request specifies a virtual address for the write operation. The virtual address must be translated into a HPA so that the write request may be implemented as a DMA write operation that writes the specified data to the correct location in physical memory specified by the HPA as translated from the virtual address specified by the write request.

In block 304, IOMMU 108 translates the virtual address of the write request to an HPA for the physical memory (e.g., RAM 110). IOMMU 108 may perform the translation using translation table 122. In one or more examples, IOMMU 108 may include a translation lookaside buffer (not shown) to increase the speed of translations. As discussed, in obtaining the HPA, IOMMU 108 is in possession of the GPA. IOMMU 108 acquires the GPA either directly from the write request or by translating the GVA into the GPA prior to performing the remainder of the translation operation to obtain the HPA. The HPA may be specified as a page identifier specifying the particular page of physical memory to which the DMA write operation is writing data (e.g., dirtying) and an offset to a location within that page to which the data is actually written. In this regard, the HPA includes a page identifier or number that uniquely identifies an IO page of physical memory and an offset into that page.

In block 306, writing to the page of the physical memory specified by the HPA is initiated. For purposes of illustration, with the translated HPA, DMA circuits (not shown) may perform the write operation interacting with memory controller 104 to perform the write operation requested in block 302. IOMMU 108 may interact with the DMA circuit(s) to effectuate the write operation.

In block 308, the IOMMU 108 and/or IOPML 130 obtains the guest physical address for the virtual address of the write request received in block 302. In one or more examples, the IOMMU 108 and/or IOPML 130 obtains the guest physical address for the virtual address of the write request by extracting the GPA from the write request itself in the case where the virtual address of the write request is the GPA. In one or more examples, where the virtual address of the write request is a GVA, the IOMMU 108 and/or IOPML 130 obtains the guest physical address by translating the GVA of the write request to the GPA. As noted, this may be performed as part of the translation operation in obtaining the HPA.

In block 310, IOMMU 108 and, more particularly, IOPML 130, is capable of tracking the dirty page by setting the dirty flag bit in translation tables 122 for the GPA. As discussed, the dirty bit flag may be set in the set of translation tables 122 that maps GVAs to GPAs and/or in the set of translation tables 122 that maps the GPAs to the HPAs. In any case, the dirty flag bit for the GPA derived from the write request of block 302 that is written in response to the write request is set. The dirty flag bit being set for the page in translation tables 122 indicates that the page is considered dirty as the page has been modified by the DMA write operation compared to what has been committed to non-volatile memory (e.g., the image file of VM 208-1) for that page.

In block 312, IOMMU 108 and, more particularly, IOPML 130, is capable of tracking the dirty pages by creating an entry in dirty page log buffer 120. IOPML 130 is capable of creating an entry at a location within dirty page log buffer 120 indicated by the tail pointer. Within dirty page log buffer 120, each entry may specify the GPA or a portion thereof such as the page identifier as obtained in block 304. The GPA, or page identifier, uniquely identifies the page of physical memory that was written responsive to the write request of block 302. As part of creating the entry in dirty page log buffer 120, IOPML 130 is capable of incrementing the tail pointer for dirty page log buffer 120.

Each entry of dirty page log buffer 120 also may be created to specify a domain identifier of the write request. The domain identifier uniquely identifies the particular VM to which the write request belongs and/or the host in the case where the write request belongs to the host (e.g., bare metal). For example, if the write request is from IO device 114-1 which on behalf of VM 208-1, the domain identifier will be a value that maps to VM 208-1 (e.g., or a particular instance thereof). In one or more examples, as part of block 310, each entry in dirty page log buffer 120 is created in response to setting a corresponding dirty flag bit (the dirty flag bit for the same dirty page) in the translation table 122.

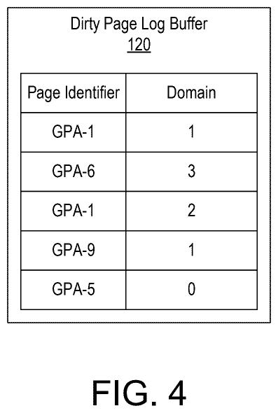

FIG. 4 illustrates an example of dirty page log buffer 120. In the example of FIG. 4, dirty page log buffer 120 includes a plurality of different entries (e.g., rows). In one or more examples, each entry may be created in response to a write request from an IO device 114 that is to be implemented via a DMA write operation. In one or more examples, each entry in dirty page log buffer 120 may be created by IOPML 130 in response to setting a dirty flag bit for the page of physical memory. That is, in response to setting a dirty flag bit for a particular page of physical memory that is written by a DMA operation initiated by an IO device, IOPML 130 generates an entry specifying the GPA of the page and a domain for that page in dirty page log buffer 120.

As may be observed in the example of FIG. 4, dirty page log buffer 120 includes only entries specifying dirty pages written, or dirtied, by DMA operations initiated by IO devices 114. Dirty page log buffer 120 does not contain any other information such as pages dirtied by CPU writes or information pertaining to clean pages explicitly. Each entry in dirty page log buffer 120 specifies a particular page of physical memory that has been written by an IO device 114 in association with, or as allocated to, a particular VM or the host system. In the example, depending on the number of VMs running in a given computing system, the number of different VMs specified in the entries of dirty page log buffer 120 may vary. That is, depending on the number of VMs running, dirty page log buffer 120 may include entries corresponding to a single VM (e.g., when only one VM is running) and/or the host system or a plurality of different VMs (e.g., when a plurality of VMs are running) and/or the host system. For purposes of illustration, the domain identifiers of 0, 1, 2, and 3 may indicate the host system, VM 208-1, VM 208-2, and VM 208-3, respectively.

As may be observed in the example of FIG. 4, a same GPA may be listed for two different domains. As shown, GPA-1 is listed in an entry for domain 1 and is listed in another entry for domain 2. Though each domain may have a same GPA-1 listed, each may be mapped to a different page 124 of physical memory. Further, because different pages 124 may be swapped by the hypervisor and/or operating system at different times for a given GPA, dirty page log buffer 120 stores GPAs as opposed to HPAs as the physical pages that are dirtied by DMA operations are to be tracked for particular domains as such domains may be the subject of a live migration.

In one or more examples, dirty page log buffer 120 may be implemented as a circular buffer. In some examples, dirty page log buffer 120 may be implemented as a dual buffer. In some aspects, the dual buffering may be implemented as ping-pong buffers. In the case of ping-pong buffers, dirty page log buffer 120 is implemented using two fixed areas of RAM 110 (or more than 2 areas/buffers of memory). In that case, IOPML 130 may write to one area/buffer of dirty page log buffer 120 while software such as hypervisor 206 reads from another area/buffer to copy the data to another larger buffer/area of RAM 110. In another aspect, the dual buffering may be implemented as a spill-over buffer such that dirty page log buffer 120 includes a first buffer and one or more spill over buffers. In that case, when the first buffer is full, IOPML 130 may create entries in, e.g., spill over to, one or more other buffers.

The type of buffering used to implement dirty page log buffer 120, e.g., whether single, ping-pong, or spill-over, may be specified as a user preference within hypervisor 206. For example, in cases where the rate of IO device page modification is high (e.g., exceeds a predetermined or threshold rate), dirty page log buffer 120 may be implemented using dual buffering (e.g., ping-pong and/or spillover), which may be specified as a user setting. In one or more examples, whether dirty page log buffer 120 is implemented (e.g., allocated by hypervisor 206) as a dual buffer and/or whether the dual buffer is implemented as a ping-pong buffer or using spillover buffers may be set automatically based on historical rates at which IO devices modify pages.

In block 314, IOMMU 108 is capable of notifying hypervisor 206 in response to creating the entry in dirty page log buffer 120. In one or more examples, IOMMU 108 is capable of implementing the notification by signaling hypervisor 206. The signaling may be the generation of an interrupt in response to creating the entry in dirty page log buffer 120. For example, the interrupt may be a message signaled interrupt (MSI) that uses in-band signaling.

In response to IOMMU 108 signaling hypervisor 206 in response to creation of an entry, a VM exit may be implemented where control is transferred from the VM (e.g., VM 208-1) back to hypervisor 206. Accordingly, hypervisor 206 is capable of decoding the VM exit reason and execute an appropriate handler. In the case of creating an entry in dirty page log buffer 120, the handler may copy the entry that was created in dirty page log buffer 120 into another buffer maintained by hypervisor 206. As the software reads the entry of dirty page log buffer 120 pointed to by the head pointer, hypervisor 206 may increment the head pointer to the next entry.

Optionally, hypervisor 206 may reset a counter for dirty page log buffer 120 to zero. Subsequently, control may be transferred back to the VM. The VM exit condition may be used in cases where the virtual CPU is in guest mode in order to switch to the hypervisor 206 to handle IOPML buffering in dirty page log buffer 120. In cases where control is already with hypervisor 206, hypervisor 206 may handle the signal from IOMMU 108 as discussed without the VM exit.

In block 316, the IOMMU 108 detects whether dirty page log buffer 120 has overflowed (e.g., an overflow of dirty page log buffer 120 has occurred). In response to detecting an overflow, method 300 may continue to block 316. In response to detecting that no overflow has occurred, method 300 may loop back to block 302 to continue monitoring and handling further write requests from IO devices 114.

In block 318, IOMMU 108 and, more particularly, IOPML 130, is capable of notifying hypervisor 206 of the detected overflow of dirty page log buffer 120. The notification may be implemented the same as or similar to the process described in connection with block 312. For example, IOMMU 108 is capable of signaling hypervisor 206 by generating an interrupt in response to detecting the overflow condition.

In response to IOMMU 108 signaling hypervisor 206 in response to a detected overflow condition, a VM exit may be implemented where control is transferred from the VM (e.g., VM 208-1) back to hypervisor 206. Accordingly, hypervisor 206 is capable of decoding the VM exit reason and executing an appropriate handler. In the case of an overflow condition for dirty page log buffer 120, the handler may copy one or more entries including the entry that was created in dirty page log buffer 120 into another buffer maintained by hypervisor 206. As hypervisor 206 reads the entry pointed to by the head pointer, hypervisor 206 is capable of incrementing the head pointer to point to the next entry in dirty page log buffer 120.

Optionally, hypervisor 206 may reset a counter for dirty page log buffer 120 to zero. Subsequently, control may be transferred back to the VM. The VM exit may be used in cases where the virtual CPU is in guest mode in order to switch to the hypervisor 206 to handle IO page log buffering in dirty page log buffer 120. In cases where control is already with hypervisor 206, hypervisor 206 may handle the signal from IOMMU 108 as discussed without the VM exit.

In one or more example implementations, in cases where an overflow condition is detected, IOMMU 108 does not write new entries into dirty page log buffer 120 but does continue setting dirty flags in translation tables 122. IOPML 130, for example, may include an overflow flag. In response to detecting an overflow condition, the overflow flag is set. While the overflow flag is set, IOPML 130 does not write new entries into dirty page log buffer 120. Once the overflow flag is cleared (e.g., by hypervisor 206 taking appropriate action), IOPML 130 may again create entries in dirty page log buffer 120 and continues to set dirty flags in translation tables 122. In such cases, however, hypervisor 206 may be required to traverse translation tables 122 to detect dirty flags that may have been set by IOMMU 108 while the overflow condition flag was set as such dirty flags will not have corresponding entries in dirty page log buffer 120.

The example of FIG. 3 illustrates how the software burden of tracking dirty IO pages for hypervisor 206 may be reduced by offloading such functions to hardware and, as such, hardware accelerating the functions. Further, the hardware generates dirty page log buffer 120, which is an in-memory log buffer visible to hypervisor 206. Accordingly, in cases where a live migration of a selected virtual machine (e.g., VM 208-1) is to occur or is occurring, hypervisor 206 is capable of obtaining a list of the dirty pages of the physical memory belonging to the selected virtual machine from dirty page log buffer 120.

Because dirty page log buffer 120 is maintained in tandem with the dirty flags of the translation tables 122, there is no need for hypervisor 206 to inspect and/or traverse translation tables 122 after the fact in the case of a live migration to discern which pages have been modified by DMA operations of IO devices 114. Dirty page log buffer 120 specifies a complete listing of the dirty IO pages for one or more given/selected VMs that is generated in real time and, as such, is immediately available to hypervisor 206 at any time. In one or more examples, hypervisor 206 is capable of copying any entries specified in dirty page log buffer 120 as they are created by virtue of the notifications described. As such, hypervisor 206 may have the list of dirty IO pages assembled and available whenever needed to support a VM live migration. Accordingly, in response to a live migration of a selected virtual machine, hypervisor 206 is capable of initiating transfer of dirty pages of the physical memory based on a list of the dirty pages belonging to the selected virtual machine being live migrated as obtained from dirty page log buffer 120.

In one or more examples, the IO page modification logging functionality may be selectively enabled by setting a control register of IOMMU 108 to enable such functions. In response to a VM live migration, hypervisor 206 is capable of passing the list of dirty pages from dirty page log buffer 120 to a live migration worker thread to effectuate VM live migration. As any additional pages are modified by DMA write operations from an IO device 114, hypervisor 206 may continue to pass such dirty pages to the worker thread at least until the live migration is complete.

The terminology used herein is for the purpose of describing particular examples only and is not intended to be limiting. Notwithstanding, several definitions that apply throughout this document are expressly defined as follows.

As defined herein, the singular forms “a,” “an,” and “the” are intended to include the plural forms as well, unless the context clearly indicates otherwise.

As defined herein, the terms “at least one,” “one or more,” and “and/or,” are open-ended expressions that are both conjunctive and disjunctive in operation unless explicitly stated otherwise.

As defined herein, the term “automatically” means without human intervention.

As defined herein, the term “computer-readable storage medium” means a storage medium that contains or stores program instructions for use by or in connection with an instruction execution system, apparatus, or device. As defined herein, a “computer-readable storage medium” is not a transitory, propagating signal per se. The various forms of memory, as described herein such as volatile and/or non-volatile memory, are examples of a computer-readable storage medium or two or more computer-readable storage mediums. A non-exhaustive list of examples of a computer-readable storage medium include an electronic storage device, a magnetic storage device, an optical storage device, an electromagnetic storage device, a semiconductor storage device, or any suitable combination of the foregoing. A non-exhaustive list of more specific examples of a computer-readable storage medium may include: a portable computer diskette, a hard disk, a RAM, a read-only memory (ROM), an erasable programmable read-only memory (EPROM or Flash memory), an electronically erasable programmable read-only memory (EEPROM), a static random-access memory (SRAM), a double-data rate synchronous dynamic RAM memory (DDR SDRAM or “DDR”), a portable compact disc read-only memory (CD-ROM), a digital versatile disk (DVD), a memory stick, a floppy disk, or the like.

As defined herein, the terms “in response to” and “responsive to” mean responding or reacting readily to an action or event. Thus, if a second action is performed “in response to” or “responsive to” a first action, there is a causal relationship between an occurrence of the first action and an occurrence of the second action. The term “responsive to” indicates the causal relationship. In some cases, other terms such as “if,” “when,” or “upon” are used and also convey a causal relationship.

As defined herein, the term “user” refers to a human being.

As defined herein, the term “hardware processor” means at least one hardware circuit. The hardware circuit may be configured to carry out program instructions (e.g., program code). The hardware circuit may be an integrated circuit. Examples of a hardware processor include, but are not limited to, a central processing unit (CPU), an array processor, a vector processor, a digital signal processor (DSP), a field-programmable gate array (FPGA), a programmable logic array (PLA), an application specific integrated circuit (ASIC), programmable logic circuitry, a controller, and a Graphics Processing Unit (GPU).

As defined herein, the term “real time” means a level of processing responsiveness that a user or system senses as sufficiently immediate for a particular process or determination to be made, or that enables the processor to keep up with some external process.

As defined herein, the term “substantially” means that the recited characteristic, parameter, or value need not be achieved exactly, but that deviations or variations, including for example, tolerances, measurement error, measurement accuracy limitations, and other factors known to those of skill in the art, may occur in amounts that do not preclude the effect the characteristic was intended to provide.

The terms first, second, etc., may be used herein to describe various elements. These elements should not be limited by these terms, as these terms are only used to distinguish one element from another unless stated otherwise or the context clearly indicates otherwise.

A computer program product may include a computer-readable storage medium (or mediums) having computer-readable program instructions thereon for causing a processor to carry out aspects of the implementations described herein. Within this disclosure, the terms “program code,” “program instructions,” and “computer-readable program instructions” are used interchangeably. Computer-readable program instructions described herein may be downloaded to respective computing/processing devices from a computer-readable storage medium or to an external computer or external storage device via a network, for example, the Internet, a LAN, a WAN and/or a wireless network. The network may include copper transmission cables, optical transmission fibers, wireless transmission, routers, firewalls, switches, gateway computers and/or edge devices including edge servers. A network adapter card or network interface in each computing/processing device receives program instructions from the network and forwards the computer-readable program instructions for storage in a computer-readable storage medium within the respective computing/processing device.

Program instructions for carrying out operations for the implementations described herein may be assembler instructions, instruction-set-architecture (ISA) instructions, machine instructions, machine dependent instructions, microcode, firmware instructions, or either source code or object code written in any combination of one or more programming languages, including an object-oriented programming language and/or procedural programming languages. Program instructions may include state-setting data. The program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a LAN or a WAN, or the connection may be made to an external computer (for example, through the Internet using an Internet Service Provider). In some cases, electronic circuitry including, for example, programmable logic circuitry, an FPGA, or a PLA may execute the program instructions by utilizing state information of the program instructions to personalize the electronic circuitry, in order to perform aspects of the implementations described herein.

Certain aspects of the implementations are described herein with reference to flowchart illustrations and/or block diagrams of methods, apparatus (systems), and computer program products. It will be understood that each block of the flowchart illustrations and/or block diagrams, and combinations of blocks in the flowchart illustrations and/or block diagrams, may be implemented by program instructions, e.g., program code.

These program instructions may be provided to a processor of a computer, special-purpose computer, or other programmable data processing apparatus to produce a machine, such that the program instructions, which execute via the processor of the computer or other programmable data processing apparatus, create means for implementing the functions/acts specified in the flowchart and/or block diagram block or blocks. These program instructions may also be stored in a computer-readable storage medium that can direct a computer, a programmable data processing apparatus, and/or other devices to function in a particular manner, such that the computer-readable storage medium having program instructions stored therein comprises an article of manufacture including program instructions which implement aspects of the operations specified in the flowchart and/or block diagram block or blocks.

The program instructions may also be loaded onto a computer, other programmable data processing apparatus, or other device to cause a series of operations to be performed on the computer, other programmable apparatus or other device to produce a computer implemented process, such that the program instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various aspects of the implementations. In this regard, each block in the flowchart or block diagrams may represent a module, segment, or portion of instructions, which comprises one or more program instructions for implementing the specified operations.

In some alternative implementations, the operations noted in the blocks may occur out of the order noted in the figures. For example, two blocks shown in succession may be executed substantially concurrently, or the blocks may sometimes be executed in the reverse order, depending upon the functionality involved. In other examples, blocks may be performed generally in increasing numeric order while in still other examples, one or more blocks may be performed in varying order with the results being stored and utilized in subsequent or other blocks that do not immediately follow. It will also be noted that each block of the block diagrams and/or flowchart illustration, and combinations of blocks in the block diagrams and/or flowchart illustration, may be implemented by special purpose hardware-based systems that perform the specified functions or acts or carry out combinations of special purpose hardware and program instructions.

The descriptions of the various implementations of the disclosed technology have been presented for purposes of illustration, but are not intended to be exhaustive or limited to the examples disclosed. Many modifications and variations will be apparent to those of ordinary skill in the art without departing from the scope and spirit of the described examples. The terminology used herein was chosen to best explain the principles of the examples, the practical application or technical improvement over technologies found in the marketplace, or to enable others of ordinary skill in the art to understand the examples disclosed herein.

What is claimed is:

1. A method, comprising:
receiving, by an input/output memory management unit (IOMMU) of a computing system, a write request from an input/output (IO) device, wherein the write request specifies a virtual address;
translating, by the IOMMU, the virtual address of the write request to a host physical address for a domain;
obtaining a guest physical address for the virtual address of the write request, wherein the guest physical address maps to a dirty page of a physical memory written in response to the write request; and
tracking, by the IOMMU, the dirty page by creating an entry in a dedicated dirty page log buffer, wherein the entry specifies, for the write request, the guest physical address and a domain identifier.

2. The method of claim 1, wherein the domain identifier specifies a virtual machine to which the write request belongs or a host system to which the write request belongs.

3. The method of claim 2, wherein the write request is one of a plurality of write requests belonging to a plurality of different virtual machines, wherein the dirty page log buffer includes entries for the plurality of write requests.

4. The method of claim 2, wherein, in response to a live migration of the virtual machine, a hypervisor translates the guest physical address of the entry from the dirty page log buffer to a host physical address and initiates transfer of the dirty page using the host physical address.

5. The method of claim 1, wherein the obtaining the guest physical address comprises:
extracting the guest physical address from the write request; or
extracting a guest virtual address from the write request and translating the guest virtual address into the guest physical address as part of the translating.

6. The method of claim 1, further comprising:
setting a dirty flag bit corresponding to the guest physical address within translation tables maintained in the physical memory, wherein the dirty page log buffer is distinct from the translation tables.

7. The method of claim 6, wherein the entry in the dirty page log buffer is created in response to setting the dirty flag bit in the translation tables.

8. The method of claim 1, wherein the write request is received by the IOMMU from the IO device requesting a direct memory access write operation.

9. The method of claim 1, wherein the dirty page log buffer is implemented as a ping-pong buffer or a spill-over buffer.

10. The method of claim 1, wherein the dirty page log buffer is implemented in the physical memory and is readable by a hypervisor.

11. The method of claim 10, further comprising:
notifying, by the IOMMU, the hypervisor in response to creating the entry in the dirty page log buffer.

12. The method of claim 10, further comprising:
notifying, by the IOMMU, the hypervisor in response to an overflow of the dirty page log buffer.

13. A computing system, comprising:
a hardware processor;
a physical memory including translation tables and a dirty page log buffer; and
an input/output memory management unit (IOMMU) coupled to the hardware processor and the physical memory, wherein the IOMMU is capable of:
receiving a write request from an input/output (IO) device, wherein the write request specifies a virtual address;
translating the virtual address of the write request to a host physical address for a domain;
obtaining a guest physical address for the virtual address of the write request, wherein the guest physical address maps to a dirty page of the physical memory written in response to the write request; and
tracking the dirty page by creating an entry in a dedicated dirty page log buffer, wherein the entry specifies, for the write request, the guest physical address and a domain identifier.

14. The computing system of claim 13, wherein the domain identifier specifies a virtual machine to which the write request belongs or a host system to which the write request belongs.

15. The computing system of claim 14, wherein the write request is one of a plurality of write requests belonging to a plurality of different virtual machines, wherein the dirty page log buffer includes entries for the plurality of write requests.

16. The computing system of claim 14, wherein, in response to a live migration of the virtual machine, a hypervisor translates the guest physical address of the entry from the dirty page log buffer to a host physical address and initiates transfer of the dirty page using the host physical address.

17. The computing system of claim 13, wherein the obtaining the guest physical address comprises:
extracting the guest physical address from the write request; or
extracting a guest virtual address from the write request and translating the guest virtual address into the guest physical address as part of the translating.

18. The computing system of claim 13, wherein the IOMMU is capable of setting a dirty flag bit corresponding to the guest physical address within translation tables maintained in the physical memory;
wherein the dirty page log buffer is distinct from the translation tables; and
wherein the entry in the dirty page log buffer is created in response to setting a corresponding dirty flag in the translation tables.

19. The computing system of claim 13, wherein the IOMMU is capable of notifying a hypervisor in response to creating the entry in the dirty page log buffer.

20. The computing system of claim 13, wherein the IOMMU is capable of notifying a hypervisor in response to an overflow of the dirty page log buffer.
